(19) United States
(12) Patent Application Publication
(10) Pub. No.: US 2023/0370884 A1
(43) Pub. Date: Nov. 16, 2023

(54) LAYER 1/LAYER 2 INTER-CELL MOBILITY MEASUREMENT REPORTING

(71) Applicant: QUALCOMM Incorporated, San Diego, CA (US)

(72) Inventors: Jelena DAMNJANOVIC, Del Mar, CA (US); Tao LUO, San Diego, CA (US); Aleksandar DAMNJANOVIC, Del Mar, CA (US)

(21) Appl. No.: 18/307,608

(22) Filed: Apr. 26, 2023

Related U.S. Application Data
(60) Provisional application No. 63/364,485, filed on May 10, 2022.

(51) Int. Cl. H04W 24/10; H04B 17/318; H04B 17/336

(52) U.S. Cl. CPC H04W 24/10; H04B 17/328; H04B 17/336

(57) ABSTRACT

Various aspects of the present disclosure generally relate to wireless communication. In some aspects, a network node may transmit a configuration associated with beam-based measurement reporting for a candidate cell group, wherein the candidate cell group is configured for layer (L1)/layer 2 (L2) mobility, and wherein the candidate cell group includes a deactivated cell. The network node may receive a message indicating a beam-based measurement for the deactivated cell according to the configuration. Numerous other aspects are described.

### CROSS-REFERENCE TO RELATED APPLICATION

This patent application claims priority to U.S. Provisional Patent Application No. 63/364,485, filed on May 10, 2022, titled “LAYER 1/LAYER 2 INTER-CELL MOBILITY MEASUREMENT REPORTING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for Layer 1/Layer 2 (L1/L2) inter-cell mobility measurement reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include transmitting a configuration associated with beam-based measurement reporting for a candidate cell group, wherein the candidate cell group is configured for layer (L1)/layer 2 (L2) mobility, and wherein the candidate cell group includes a deactivated cell. The method may include receiving a message indicating a beam-based measurement for the deactivated cell according to the configuration.

Some aspects described herein relate to a method of wireless communication performed by a user equipment (UE). The method may include receiving a configuration associated with beam-based reporting for a candidate cell group, wherein the candidate cell group is configured for L1/L2 mobility, and wherein the candidate cell group includes a deactivated cell. The method may include transmitting a message indicating a beam-based measurement for the deactivated cell according to the configuration.

Some aspects described herein relate to a method of wireless communication performed by a network node. The method may include transmitting a configuration for UE-triggered beam-based measurement reporting, the configuration indicating that a beam-based measurement report is transmitted by a UE based at least in part on a condition associated with beam-based measurement reporting being satisfied. The method may include receiving the beam-based measurement report based at least in part on the condition being satisfied.

Some aspects described herein relate to a method of wireless communication performed by a UE. The method may include determining that a condition associated with beam-based measurement reporting is satisfied. The method may include transmitting a beam-based measurement report based at least in part on the condition being satisfied.

Some aspects described herein relate to a network node for wireless communication. The network node may include a memory and one or more processors coupled to the memory. The one or more processors may be configured to transmit a configuration associated with beam-based measurement reporting for a candidate cell group, wherein the candidate cell group is configured for L1/L2 mobility, and wherein the candidate cell group includes a deactivated cell. The one or more processors may be configured to receive a message indicating a beam-based measurement for the deactivated cell according to the configuration.

Some aspects described herein relate to a UE for wireless communication. The user equipment may include a memory and one or more processors coupled to the memory. The one or more processors may be configured to receive a configuration associated with beam-based measurement reporting for a candidate cell group, wherein the candidate cell group is configured for L1/L2 mobility, and wherein the candidate cell group includes a deactivated cell. The one or more processors may be configured to transmit a message indicating a beam-based measurement for the deactivated cell according to the configuration.

Some aspects described herein relate to a network node for wireless communication. The network node may include a memory and one or more processors coupled to the memory. The one or more processors may be configured to transmit a configuration for UE-triggered beam-based measurement reporting, the configuration indicating that a beam-based measurement report is transmitted by a UE based at least in part on a condition associated with beam-based measurement reporting being satisfied. The one or more processors may be configured to receive the beam-based measurement report based at least in part on the condition being satisfied.

Some aspects described herein relate to UE for wireless communication. The UE may include a memory and one or more processors coupled to the memory. The one or more processors may be configured to determine that a condition associated with beam-based measurement reporting is satisfied. The one or more processors may be configured to transmit a beam-based measurement report based at least in part on the condition being satisfied.

Some aspects described herein relate to a non-transitory computer-readable medium that stores a set of instructions for wireless communication by a network node. The set of instructions, when executed by one or more processors of the network node, may cause the network node to transmit a configuration associated with beam-based measurement reporting for a candidate cell group, wherein the candidate cell group is configured for L1/L2 mobility, and wherein the candidate cell group includes a deactivated cell. The set of instructions, when executed by one or more processors of the network node, may cause the network node to receive a message indicating a beam-based measurement for the deactivated cell according to the configuration.

Some aspects described herein relate to a non-transitory computer-readable medium that stores a set of instructions for wireless communication by a UE. The set of instructions, when executed by one or more processors of the UE, may cause the UE to receive a configuration associated with beam-based measurement reporting for a candidate cell group, wherein the candidate cell group is configured for L1/L2 mobility, and wherein the candidate cell group includes a deactivated cell. The set of instructions, when executed by one or more processors of the UE, may cause the UE to transmit a message indicating a beam-based measurement for the deactivated cell according to the configuration.

Some aspects described herein relate to a non-transitory computer-readable medium that stores a set of instructions for wireless communication by a network node. The set of instructions, when executed by one or more processors of the network node, may cause the network node to transmit a configuration for UE-triggered beam-based measurement reporting, the configuration indicating that a beam-based measurement report is transmitted by a UE based at least in part on a condition associated with beam-based measurement reporting being satisfied. The set of instructions, when executed by one or more processors of the network node, may cause the network node to receive the beam-based measurement report based at least in part on the condition being satisfied.

Some aspects described herein relate to a non-transitory computer-readable medium that stores a set of instructions for wireless communication by a UE. The set of instructions, when executed by one or more processors of the network node, may cause the UE to determine that a condition associated with beam-based measurement reporting is satisfied. The set of instructions, when executed by one or more processors of the UE, may cause the UE to transmit a beam-based measurement report based at least in part on the condition being satisfied.

Some aspects described herein relate to an apparatus for wireless communication. The apparatus may include means for transmitting a configuration associated with beam-based measurement reporting for a candidate cell group, wherein the group of cells is configured for L1/L2 mobility, and wherein the candidate cell group includes a deactivated cell. The apparatus may include means for receiving a message indicating a beam-based measurement for the deactivated cell according to the configuration.

Some aspects described herein relate to an apparatus for wireless communication. The apparatus may include means for receiving a configuration associated with beam-based measurement reporting for a candidate cell group, wherein the candidate cell group is configured for L1/L2 mobility, and wherein the candidate cell group includes a deactivated cell. The apparatus may include means for transmitting a message indicating a beam-based measurement for the deactivated cell according to the configuration.

Some aspects described herein relate to an apparatus for wireless communication. The apparatus may include means for transmitting a configuration for UE-triggered beam-based measurement reporting, the configuration indicating that a beam-based measurement report is transmitted by a UE based at least in part on a condition associated with beam-based measurement reporting being satisfied. The apparatus may include means for receiving the beam-based measurement report based at least in part on the condition being satisfied.

Some aspects described herein relate to an apparatus for wireless communication. The apparatus may include means for determining that a condition associated with beam-based measurement reporting is satisfied. The apparatus may include means for transmitting a beam-based measurement report based at least in part on the condition being satisfied.

Aspects generally include a method, apparatus, system, computer program product, non-transitory computer-readable medium, user equipment, base station, wireless communication device, and/or processing system as substantially described herein with reference to and as illustrated by the drawings and the specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIGS. 4A and 4B are diagrams illustrating examples of Layer 1/Layer 2 (L1/L2) inter-cell mobility, in accordance with the present disclosure.

FIGS. 5 and 6 are diagrams illustrating examples associated with L1/L2 inter-cell mobility measurement reporting, in accordance with the present disclosure.

FIGS. 7-10 are diagrams illustrating example processes associated with L1/L2 inter-cell mobility measurement reporting, in accordance with the present disclosure.

FIGS. 11-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

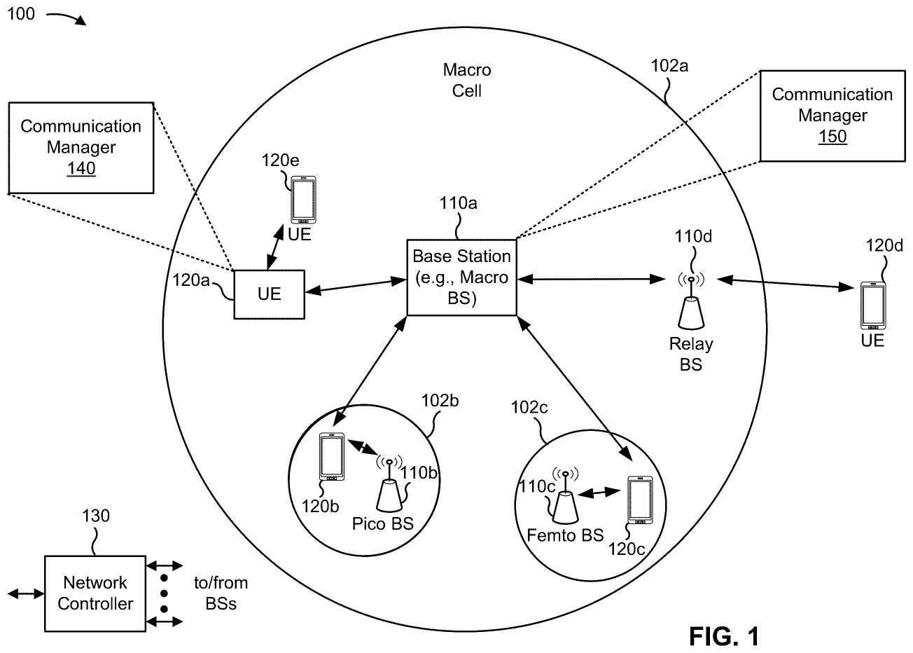

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the base station may include a communication manager 150. As described in more detail elsewhere herein, the communication manager 150 may transmit a configuration associated with beam-based measurement reporting for a candidate cell group, wherein the candidate cell group is configured for layer 1 (L1)/layer 2 (L2) mobility, and wherein the candidate cell group includes a deactivated cell; and may receive a message indicating a beam-based measurement for the deactivated cell according to the configuration.

In some aspects, as described in more detail elsewhere herein, the communication manager 150 may transmit a configuration for user equipment (UE)-triggered beam-based measurement reporting, the configuration indicating that a beam-based measurement report is transmitted by a UE based at least in part on a condition associated with beam-based measurement reporting being satisfied; and may receive the beam-based measurement report based at least in part on the condition being satisfied. Additionally, or alternatively, the communication manager 150 may perform one or more other operations described herein.

In some aspects, the UE 120 may include a communication manager 140. As described in more detail elsewhere herein, the communication manager 140 may receive a configuration associated with beam-based measurement reporting for a candidate cell group, wherein the candidate cell group is configured for L1/L2 mobility, and wherein the candidate cell group includes a deactivated cell; and transmit a message indicating an L1 measurement for the deactivated cell according to the configuration.

In some aspects, as described in more detail elsewhere herein, the communication manager 140 may determine that a condition associated with beam-based measurement reporting is satisfied; and may transmit a beam-based measurement report based at least in part on the condition being satisfied. Additionally, or alternatively, the communication manager 140 may perform one or more other operations described herein.

As described herein, a node, which may be referred to as a “node,” a “network node,” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

As indicated above, FIG. 1 is provided as an example. Other examples may differ from what is described with regard to FIG. 1.

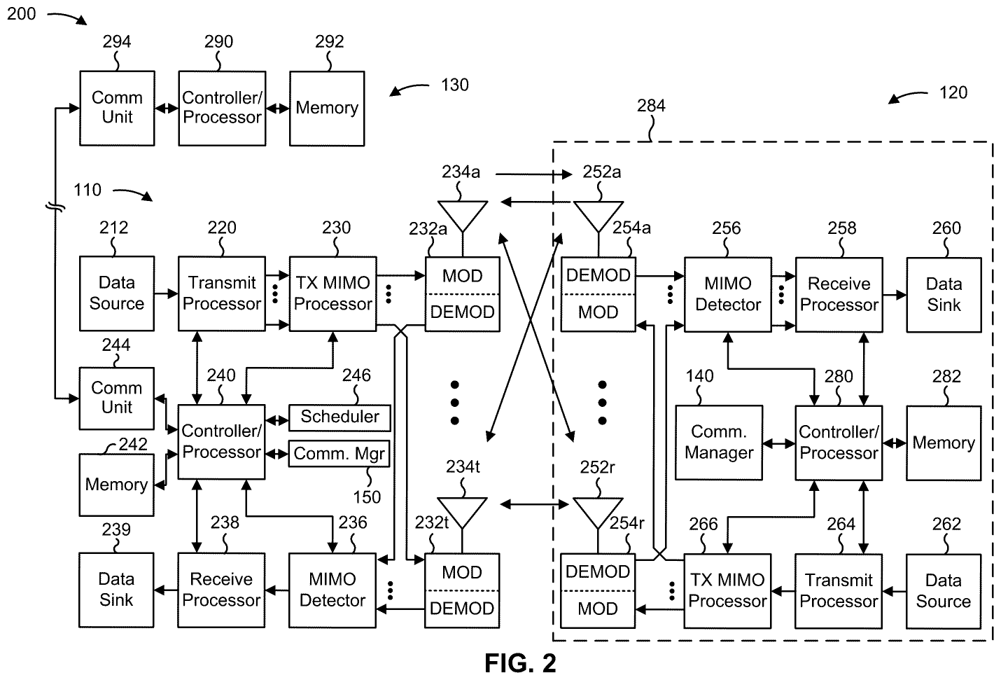

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

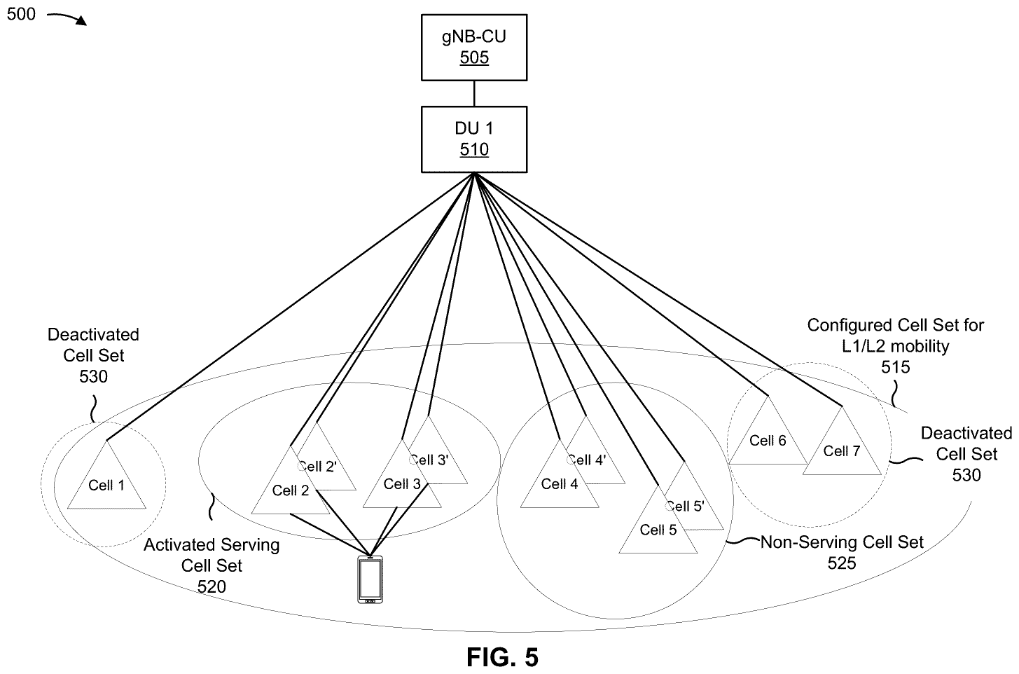

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-14).

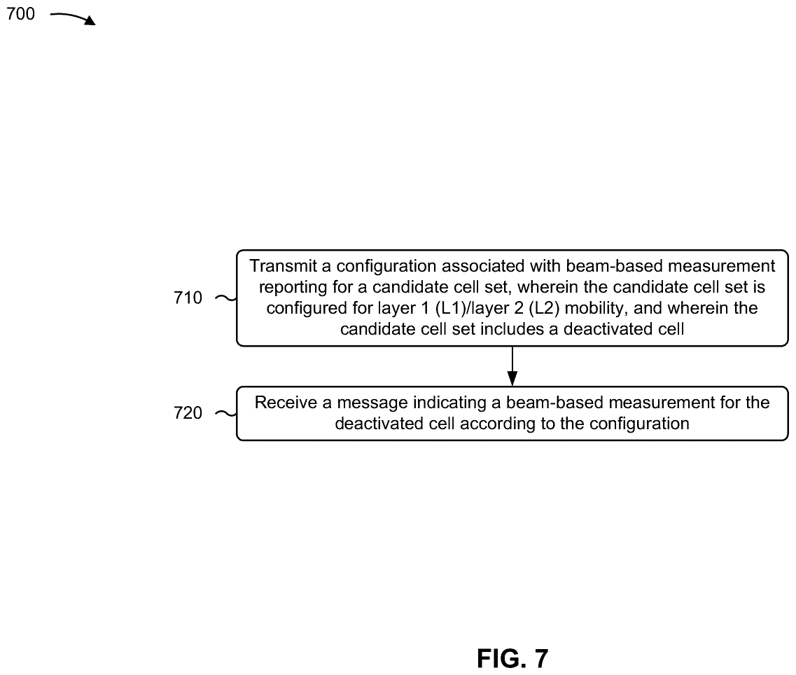

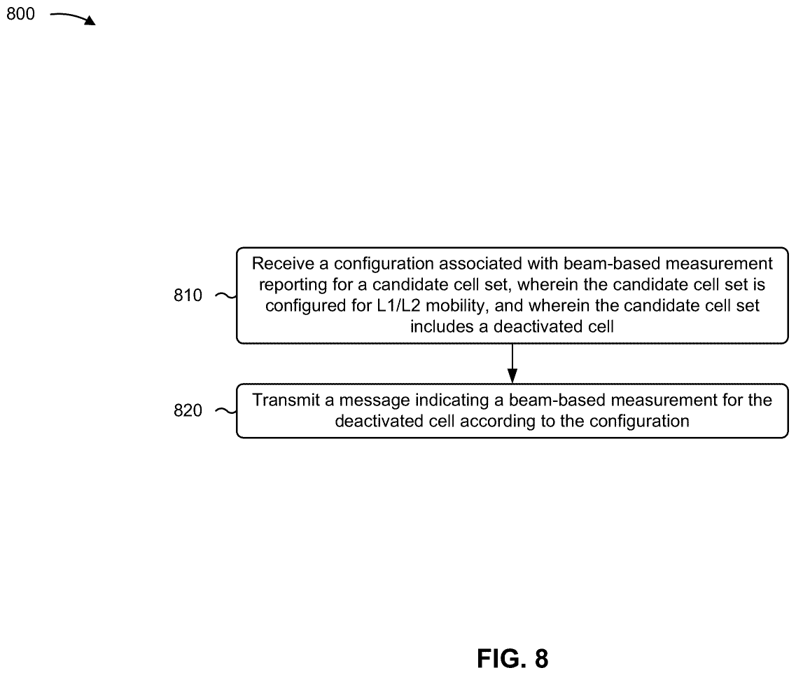

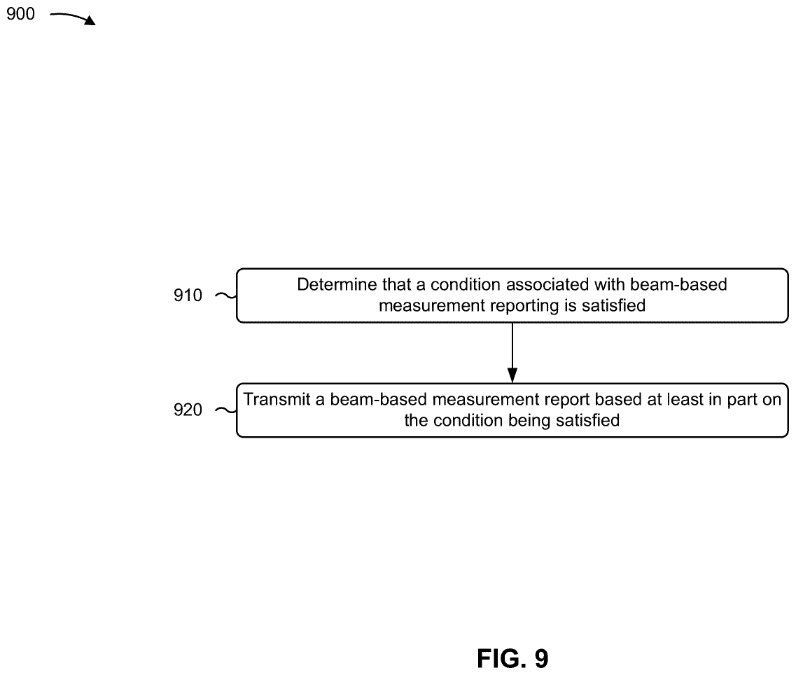

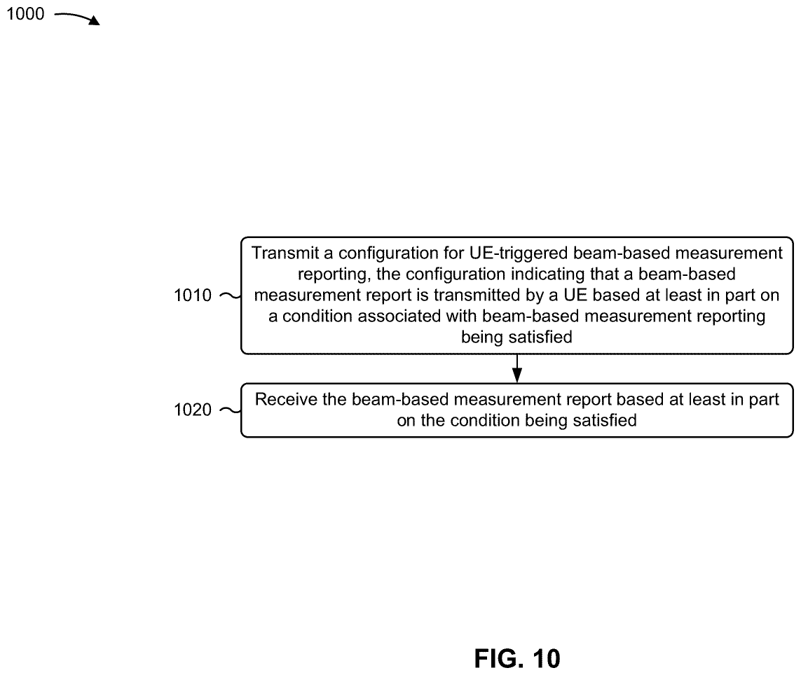

The controller/processor 240 of the base station 110, the controller/processor 280 of the UE 120, and/or any other component(s) of FIG. 2 may perform one or more techniques associated with L1/L2 inter-cell mobility measurement reporting, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a network node (e.g., the base station 110) includes means for transmitting a configuration associated with beam-based measurement reporting for a candidate cell group, wherein the candidate cell group is configured for L1/L2 mobility, and wherein the candidate cell group includes a deactivated cell; and/or means for receiving a message indicating a beam-based measurement for the deactivated cell according to the configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network node (e.g., the base station 110) includes means for transmitting a configuration for UE-triggered beam-based measurement reporting, the configuration indicating that a beam-based measurement report is transmitted by a UE based at least in part on a condition associated with beam-based measurement reporting being satisfied; and/or means for receiving the beam-based measurement report based at least in part on the condition being satisfied. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., the UE 120) includes means for receiving a configuration associated with L1 measurement reporting for a candidate cell group, wherein the candidate cell group is configured for L1/L2 mobility, and wherein the candidate cell group includes a deactivated cell; and/or means for transmitting a message indicating an L1 measurement for the deactivated cell according to the configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., the UE 120) includes means for determining that a condition associated with beam-based measurement reporting is satisfied; and/or means for transmitting a beam-based measurement report based at least in part on the condition being satisfied. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the term “base station” (e.g., the base station 110) may refer to an aggregated base station, a disaggregated base station, and/or one or more components of a disaggregated base station. For example, in some aspects, “base station” may refer to a control unit, a distributed unit, a plurality of control units, a plurality of distributed units, and/or a combination thereof. In some aspects, “base station” may refer to one device configured to perform one or more functions such as those described above in connection with the base station 110. In some aspects, “base station” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” may refer to any one or more of those different devices. In some aspects, “base station” may refer to one or more virtual base stations, one or more virtual base station functions, and/or a combination of thereof. For example, in some cases, two or more base station functions may be instantiated on a single device. In some aspects, “base station” may refer to one of the base station functions and not another. In this way, a single device may include more than one base station.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

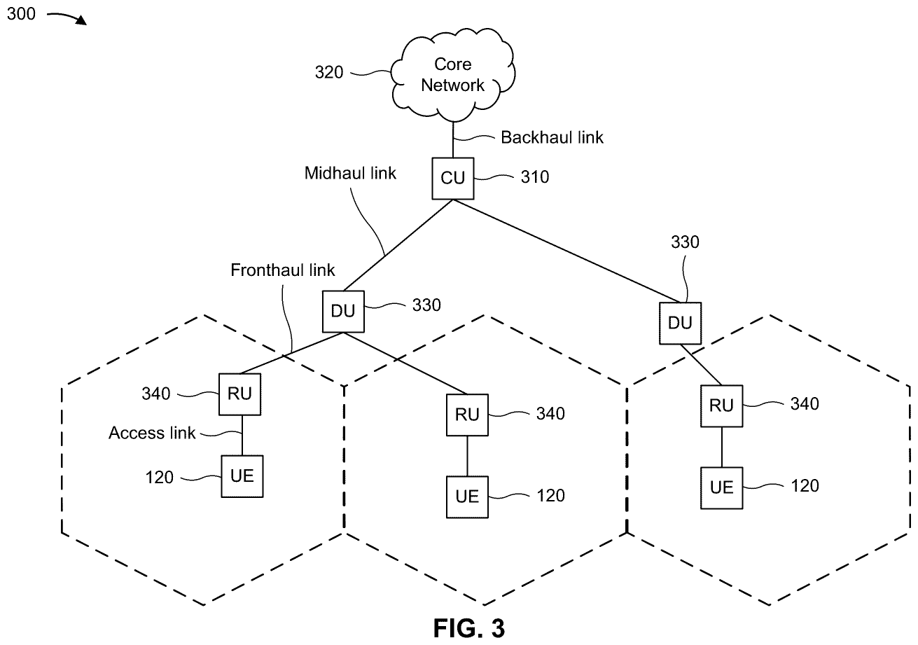

FIG. 3 is a diagram illustrating an example 300 of an open RAN (O-RAN) architecture, in accordance with the present disclosure. As shown in FIG. 3, the O-RAN architecture may include a CU 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via RF access links. The DUs 330 and the RUs 340 may also be referred to as O-RAN DUs (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

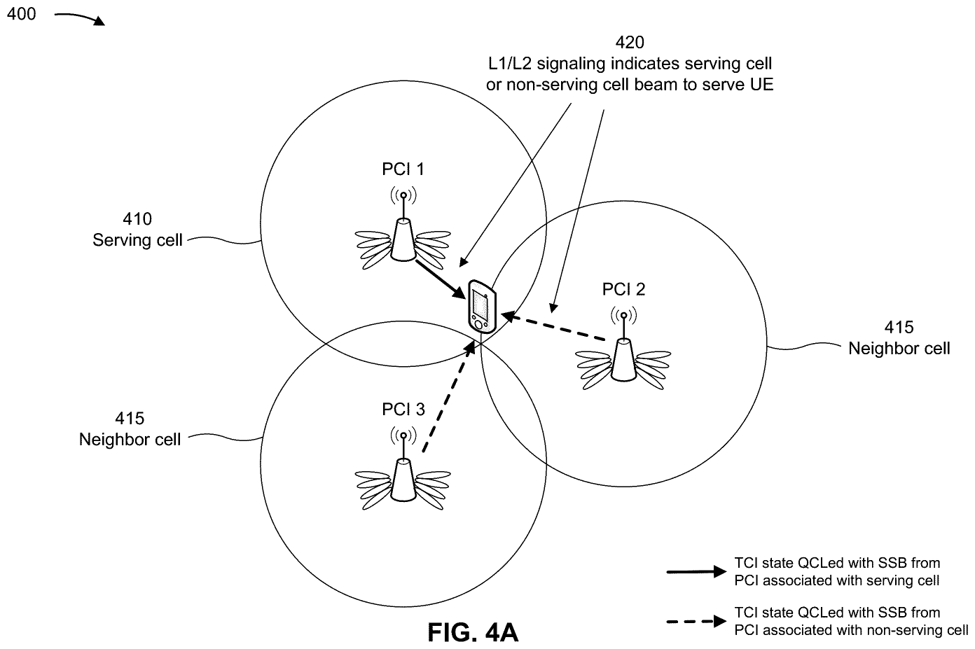

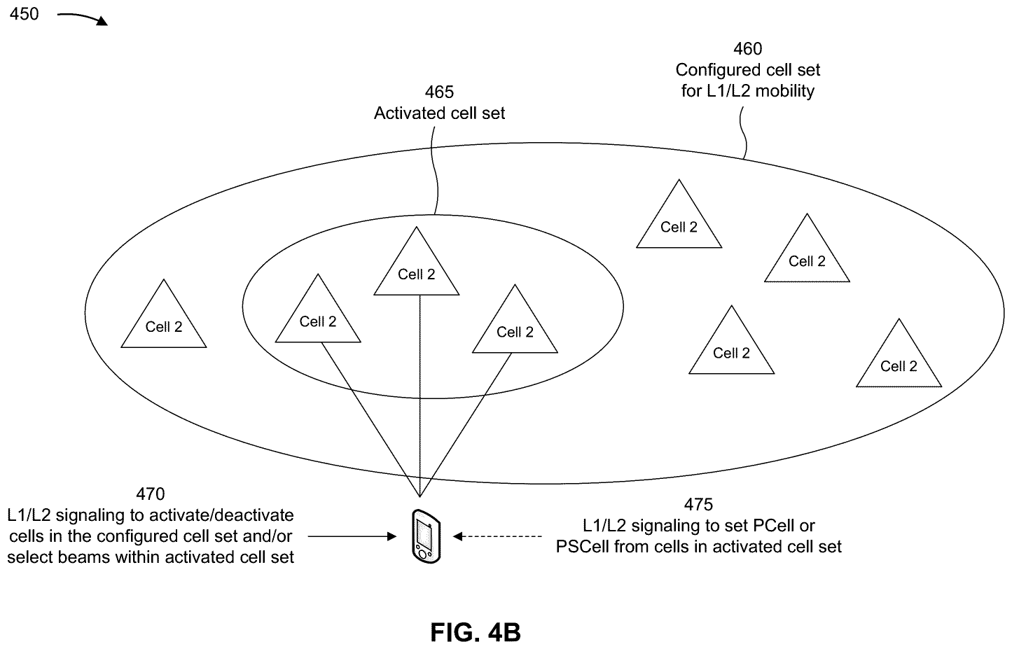

FIGS. 4A and 4B are diagrams illustrating examples 400, 450 of L1/L2 inter-cell mobility, in accordance with the present disclosure.

In a wireless network, such as an NR network, a UE and a base station may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples.

Further, a wireless network may support multi-beam operation in a relatively high carrier frequency (e.g., within FR2), which may be associated with harsher propagation conditions than comparatively lower carrier frequencies. For example, relative to a sub-6 gigahertz (GHz) band, signals propagating in a millimeter wave frequency band may suffer from increased pathloss and severe channel intermittency, and/or may be blocked by objects commonly present in an environment surrounding the UE (e.g., a building, a tree, and/or a body of a user, among other examples).

One possible enhancement for multi-beam operation in a higher carrier frequency is facilitation of efficient (e.g., low latency and low overhead) downlink and/or uplink beam management to support higher L1/L2-centric inter-cell mobility. Accordingly, one goal for L1/L2-centric inter-cell mobility is to enable a UE to perform a cell switch via dynamic control signaling at lower layers (e.g., downlink control information (DCI) for L1 signaling or a MAC control element (MAC-CE) for L2 signaling) rather than semi-static Layer 3 (L3) RRC signaling in order to reduce latency, reduce overhead, and/or otherwise increase efficiency of the cell switch.

For example, FIG. 4A illustrates an example 400 of a first L1/L2 inter-cell mobility technique, which may be referred to as inter-cell mobility scheme 1, beam-based inter-cell mobility, dynamic point selection based inter-cell mobility, and/or non-serving cell-based inter-cell mobility, among other examples. As described in further detail herein, the first L1/L2 inter-cell mobility technique may enable a base station to use L1 signaling (e.g., DCI) or L2 signaling (e.g., a MAC-CE) to indicate that a UE is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identity (PCI) associated with a serving cell. In contrast, in a wireless network that supports the first L1/L2 inter-cell mobility technique (e.g., as shown in FIG. 4A), beam selection for control and data may be expanded to include any beams within a serving cell 410 or one or more non-serving neighbor cells 415 configured for L1/L2 inter-cell mobility.

For example, in the first L1/L2 inter-cell mobility technique shown in FIG. 4A, a UE may be configured with a single serving cell 410, and the UE may be further configured with a neighbor cell set that includes one or more non-serving neighbor cells 415 configured for L1/L2 inter-cell mobility. In general, the serving cell 410 and the non-serving neighbor cells 415 that are configured for L1/L2 inter-cell mobility may be associated with a common CU and a common DU, or the serving cell 410 and the non-serving neighbor cells 415 configured for L1/L2 inter-cell mobility may be associated with a common CU and different DUs. In some aspects, as shown by reference number 420, a base station may trigger L1/L2 inter-cell mobility for a UE using L1/L2 signaling (e.g., DCI or a MAC-CE) that indicates a selected transmission configuration indication (TCI) state quasi co-located (QCLed) with a reference signal (e.g., a synchronization signal block (SSB)) associated with a PCI. For example, in FIG. 4A, the UE may be communicating with the serving cell 410 using a TCI state that is QCLed with an SSB from a PCI associated with the serving cell 410 (e.g., shown as PCI 1 in FIG. 4A), and L1/L2 signaling may trigger inter-cell mobility by indicating that the UE is to switch to communicating using a TCI state that is QCLed with an SSB from a PCI associated with a non-serving neighbor cell 415 (e.g., shown as PCI 2 in FIG. 4A). Accordingly, in the first L1/L2 inter-cell mobility technique, the base station (e.g., the common CU controlling the serving cell 410 and the non-serving neighbor cells 415) may use L1/L2 signaling to select a beam from either the serving cell 410 or a non-serving neighbor cell 415 to serve the UE.

In this way, relative to restricting L1/L2 beam selection to beams within the serving cell 410, the first L1/L2 inter-cell mobility technique may be more robust against blocking and may provide more opportunities for higher rank spatial division multiplexing across different cells. However, the first L1/L2 inter-cell mobility technique does not enable support for changing a primary cell (PCell) or a primary secondary cell (PSCell) for a UE. Rather, in the first L1/L2 inter-cell mobility technique, triggering a PCell or PSCell change is performed via a legacy L3 handover using RRC signaling. In this respect, the first L1/L2 inter-cell mobility technique is associated with a limitation that L1/L2 signaling can only be used to indicate a beam from the serving cell 410 or a configured non-serving neighbor cell 415 while the UE is in the coverage area of the serving cell 410 because L1/L2 signaling cannot be used to change the PCell or PSCell.

Accordingly, FIG. 4B illustrates an example 450 of a second L1/L2 inter-cell mobility technique, which may be referred to as inter-cell mobility scheme 2 and/or serving cell-based inter-cell mobility, among other examples. As described in further detail herein, the second L1/L2 inter-cell mobility technique may enable a base station to use L1/L2 signaling (e.g., DCI or a MAC-CE) to indicate control information associated with an activated cell set and/or a deactivated cell set and/or to indicate a change to a PCell or a PSCell within the activated cell set.

For example, as shown in FIG. 4B, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 4B, a base station may configure a cell set 460 for L1/L2 inter-cell mobility (e.g., using RRC signaling). As further shown, an activated cell set 465 may include one or more cells in the configured cell set 460 that are activated and ready to use for data and/or control transfer. Accordingly, in the second L1/L2 inter-cell mobility technique, a deactivated cell set may include one or more cells that are included in the cell set 460 configured for L1/L2 inter-cell mobility but are not included in the activated cell set 465. However, the cells that are included in the deactivated cell set can be readily activated, and thereby added to the activated cell set 465, using L1/L2 signaling. Accordingly, as shown by reference number 470, L1/L2 signaling can be used for mobility management of the activated cell set 465. For example, in some aspects, L1/L2 signaling can be used to activate cells within the configured cell set 460 (e.g., to add cells to the activated cell set 465), to deactivate cells in the activated cell set 465, and/or to select beams within the cells included in the activated cell set 465. In this way, the second L1/L2 inter-cell mobility technique may enable seamless mobility among the cells included in the activated cell set 465 using L1/L2 signaling (e.g., using beam management techniques).

Furthermore, as shown by reference number 475, the second L1/L2 inter-cell mobility technique enables using L1/L2 signaling to set or change a PCell or PSCell from the cells that are included in the activated cell set 465. Additionally, or alternatively, when the cell to become the new PCell or PSCell is in the deactivated cell set (e.g., is included in the cell set 460 configured for L1/L2 mobility but not the activated cell set 465), L1/L2 signaling can be used to move the cell from the deactivated cell set to the activated cell set 465 before further L1/L2 signaling is used to set the cell as the new PCell or PSCell. However, in the second L1/L2 inter-cell mobility techniques, an L3 handover (using RRC signaling) is used to change the PCell or PSCell when the new PCell or PSCell is not included in the cell set 460 configured for L1/L2 inter-cell mobility. In such cases, RRC signaling associated with the L3 handover may be used to update the cells included in the cell set 460 that is configured for L1/L2 inter-cell mobility.

Accordingly, as described herein, L1/L2 inter-cell mobility can provide more efficient cell switching to support multi-beam operation, enabling lower latency and reduced overhead by using L1 signaling (e.g., DCI) and/or L2 signaling (e.g., a MAC-CE) rather than L3 signaling (e.g., RRC) to change the beam(s) used by a UE to transfer control information and/or data over an access link. However, L1/L2 inter-cell mobility may rely on L1 measurements (e.g., beam-based measurements) of the configured cell set (e.g., cell set 460) and L1 measurement reporting (e.g., beam-based measurement reporting) for deactivated cells in the context of carrier aggregation is not supported. Therefore, a base station may not be able to determine whether it is beneficial to a UE to add a particular deactivated cell to the activated cell set 465.

Some aspects described herein provide techniques and apparatuses for enabling L1 measurement reporting (e.g., beam-based measurement reporting) for a candidate cell for L1/L2 mobility. A candidate cell for L1/L2 mobility may comprise a cell that is configured for L1/L2 mobility that can be an activated serving cell, a deactivated cell, or a non-serving cell.

As indicated above, FIGS. 4A and 4B are provided as examples. Other examples may differ from what is described with regard to FIGS. 4A and 4B.

FIG. 5 is a diagram illustrating an example 500 of L1/L2 inter-cell mobility measurements and reporting, in accordance with the present disclosure.

As shown in FIG. 5, a base station may include a CU 505 and a DU 510 associated with a plurality of cells. The base station may configure the plurality of cells to form a cell set 515 for L1/L2 inter-cell mobility. The configured cell set 515 (e.g., a candidate cell set for L1/L2 mobility) may include an activated serving cell set 520, a non-serving cell set 525, and a deactivated cell set 530.

As shown in FIG. 5, in some aspects, the configured cell set 515 (e.g., the activated serving cell set 520, the non-serving cell set 525, and the deactivated cell set 530) may be associated with a common CU (e.g., CU 505) and a common DU (e.g., DU 510). In some aspects, the configured cell set 515 may be associated with a common CU (e.g., CU 505) and different DUs. As an example, the CU 505 may be associated with the DU 510 and another DU (not shown). The activated serving cell set 520 may be associated with the DU 510, and one or more of the non-serving cell set 525 or the deactivated cell set 530 may be associated with the other DU.

In some aspects, the activated serving cell set 520 may include one or more cells in the configured cell set 515 that are activated and ready to be used for data and/or control transfer. The non-serving cell set 525 may include one or more cells in the configured cell set 515 that a UE may autonomously choose to add to the activated serving cell set 520. The deactivated cell set 530 may include one or more cells in the configured cell set 515 that are not included in the activated serving cell set 520 or the non-serving cell set 525.

In some aspects, a cell may be moved to and/or removed from a particular cell set using L1/L2 signaling. For example, L1/L2 signaling may be utilized to activate a deactivated cell included in the deactivated cell set 530 and/or add the activated cell to the activated serving cell set 520 or the non-serving cell set 525.

In some aspects, a single cell (e.g., a cell associated with a particular PCI) may be configured to comprise multiple activated cells (e.g., multiple cells included in the activated serving cell set 520), multiple candidate cells (e.g., multiple cells included in the non-serving cell set 525), and/or multiple deactivated cells (e.g., multiple cells included in the deactivated cell set 530). For example, a UE may have multi-carrier support and an activated cell may be associated with a group of component carriers. The activated serving cell set 520 may be configured to include a first cell (shown as Cell 2) that is associated with a first subset of the group of component carriers and a second cell (shown as Cell 2′) that is associated with a second subset of the group of component carriers.

In some aspects, the base station may utilize L1/L2 signaling to set or change a PCell or PSCell from the cells that are included in the activated serving cell set 520. Additionally, or alternatively, the base station may utilize L1/L2 signaling to configure one or more cells included in the non-serving cell set 525 and/or one or more cells in the deactivated cell set 530 as a potential PCell or PSCell. In some aspects, the base station and/or a UE may utilize L1/L2 signaling to change from a PCell or PSCell included in the activated serving cell set 520 to a potential PCell or PSCell included in the non-serving cell set 525 and/or the deactivated cell set 530 based at least in part on one or more L1 measurements reported to the base station by the UE, as described in greater detail elsewhere herein.

As indicated above, FIG. 5 is provided as an example. Other examples may differ from what is described with respect to FIG. 5.

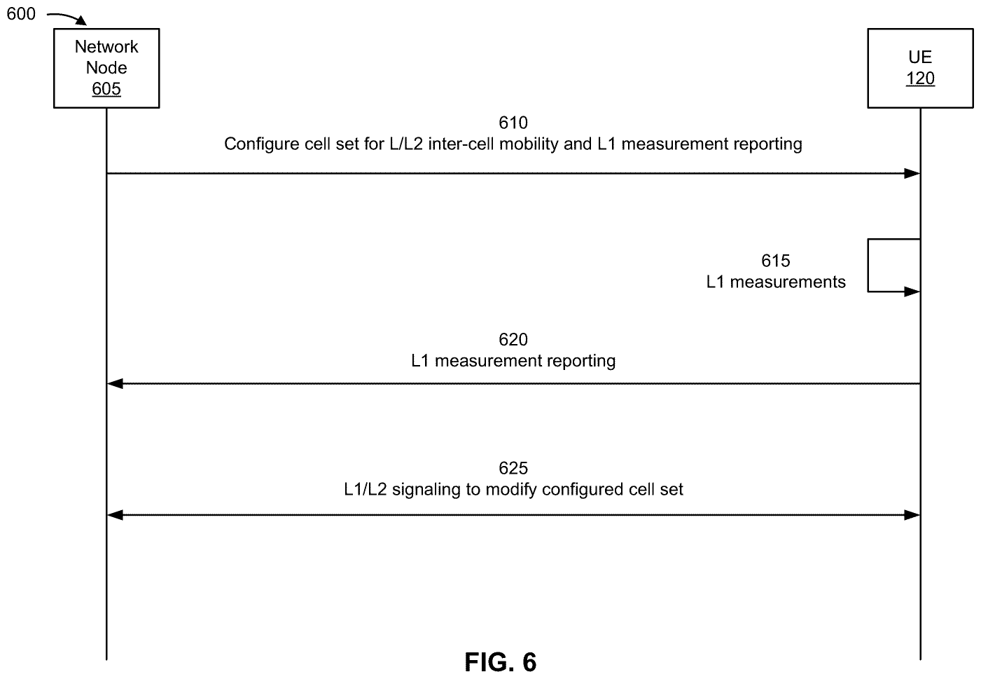

FIG. 6 is a diagram illustrating an example 600 associated with L1/L2 inter-cell mobility measurement reporting, in accordance with the present disclosure. As shown in FIG. 6, example 600 includes communication between a network node 605 (e.g., one or more components of a base station 110) and a UE 120. In some aspects, the UE 120 and the network node 605 may be included in a wireless network, such as wireless network 100. The UE 120 and the network node 605 may communicate via a wireless access link, which may include an uplink and a downlink. Furthermore, as described herein, the wireless network in which the UE 120 and the network node 605 communicate may support one or more L1/L2 inter-cell mobility techniques described elsewhere herein.

As shown by reference number 610, the network node 605 may transmit, and the UE 120 may receive, signaling (e.g., RRC signaling) that configures one or more cells for L1/L2 inter-cell mobility (e.g., an L1/L2 inter-cell mobility configuration) and configures L1 measurement reporting by the UE 120 (e.g., an L1 measurement reporting configuration). In some aspects, the network node 605 may transmit signaling that configures a set of cells for L1/L2 inter-cell mobility, as described elsewhere herein.

In some aspects, the L1/L2 inter-cell mobility configuration may configure an activated serving cell set, a non-serving cell set, and/or a deactivated cell set, as described elsewhere herein. In some aspects, the L1/L2 inter-cell mobility configuration may be based at least in part on a capability of the UE 120. For example, the UE 120 may transmit (e.g., via RRC signaling) capability information indicating a capability of the UE 120 to support L1/L2 inter-cell mobility and/or one or more L1/L2 inter-cell mobility techniques (e.g., one or more L1/L2 inter-cell mobility techniques described above with respect to FIGS. 4A, 4B, and 5).

In some aspects, the L1 measurement reporting configuration may indicate one or more cells and/or one or more groups of cells included in the configured cell set for which L1 measurements are to be performed and/or for which L1 measurement reporting is to be performed. For example, the L1 measurement reporting configuration may indicate that L1-signal-to-interference-plus-noise ratio (SINR) measurements, L1-reference signal received power (RSRP) measurements, and/or L1 measurement reporting is to be performed for one or more cells included in the activated serving cell set, one or more cells included in the non-serving cell set, and/or one or more cells included in the deactivated cell set.

In some aspects, the L1 measurement reporting configuration may indicate a method for determining the one or more cells included in the activated serving cell set, the non-serving cell set, and/or the deactivated cell set. For example, the L1 measurement reporting configuration may indicate that the one or more cells included in the activated serving cell set, the non-serving cell set, and/or the deactivated cell set correspond to one or more cells included in the activated serving cell set, the non-serving cell set, and/or the deactivated cell set at a time at which the L1 measurement reporting is transmitted to the network node 605, a time at which the L1 measurement is obtained, a fixed set of cells irrespective of a cell set in which the cells are included, and/or as indicated in the L1/L2 inter-cell mobility configuration, among other examples.

In some aspects, the L1 measurement reporting configuration may indicate one or more resources for transmitting an L1 measurement report. In some aspects, the L1 measurement reporting configuration may indicate that L1 measurement reporting is to be transmitted periodically to the network node 605. In some aspects, the L1 measurement reporting configuration may indicate one or more resources (e.g., one or more physical uplink control channel (PUCCH) resources) for periodically transmitting the L1 measurement reporting.

In some aspects, the L1 measurement reporting configuration may indicate that the L1 measurement reporting is semi-persistent L1 measurement reporting. For example, the L1 measurement reporting configuration may indicate that the L1 measurement reporting is triggered based at least in part on receiving an activation command for transmission on a PUCCH and/or DCI triggered for transmission on a physical uplink shared channel (PUSCH).

In some aspects, the L1 measurement reporting configuration may indicate that the L1 measurement reporting is aperiodic L1 measurement reporting. For example, the L1 measurement reporting configuration may indicate that the L1 measurement reporting is triggered based at least in part on receiving DCI scheduling a PUSCH for transmitting the L1 measurement reporting.

In some aspects, the L1 measurement reporting configuration may indicate that the L1 measurement reporting is measurement triggered aperiodic L1 measurement reporting. For example, the L1 measurement reporting configuration may indicate that L1 measurement reporting is transmitted based at least in part on an occurrence of a measurement event. In some aspects, the measurement event may include an L1 measurement for an activated cell, an L1 measurement for a candidate cell, and/or an L1 measurement for a deactivated cell satisfying a measurement threshold (e.g., being greater than a measurement threshold, being less than a measurement threshold, or crossing a measurement threshold, among other examples).

In some aspects, the measurement event may include an L1 measurement for a first cell (e.g., an activated serving cell, a non-serving cell, and/or a deactivated cell) being greater than (or less than) an L1 measurement for a second cell (e.g., another activated serving cell, a cell configured as a PCell for the UE 120, a cell configured as a PSCell for the UE 120, a non-serving cell, and/or a deactivated cell). For example, the L1 measurement reporting configuration may indicate that L1 measurement reporting is transmitted to the network node 605 based at least in part on an L1 measurement for a deactivated cell being at least an offset different from (e.g., greater or lesser than) an L1 measurement for an activated serving cell (e.g., a PCell and/or a PSCell).

In some aspects, the measurement event may include multiple measurement events. For example, the L1 measurement reporting configuration may indicate that L1 measurement reporting is transmitted to the network node 605 based at least in part on an L1 measurement associated with an activated serving cell (e.g., an activated serving cell configured as a PCell) satisfying a first threshold and an L1 measurement associated with a non-serving cell (e.g., a non-serving cell configured as a candidate PCell) and/or a deactivated cell (e.g., a deactivated cell configured as a candidate PCell) satisfying a second threshold. The first threshold may be the same as, or different from, the second threshold.

In some aspects, the L1 measurement reporting configuration may indicate that the measurement event is associated with modifying the configured set of cells. For example, the L1 measurement reporting configuration may indicate that the measurement event is associated with deactivating an activated serving cell and moving the deactivated cell from the activated serving cell set to the deactivated cell set, activating a deactivated cell and moving the activated serving cell from the deactivated cell set to the activated serving cell set, activating a deactivated cell and moving the activated cell from the deactivated cell set to the non-serving cell set, and/or moving a non-serving cell from the non-serving cell set to the activated serving cell set. Additionally, or alternatively, the L1 measurement reporting configuration may indicate that the measurement event is associated with changing a PCell and/or a PSCell to a candidate PCell and/or a candidate PSCell.

In some aspects, the L1 measurement reporting configuration may indicate an L1 measurement reporting format. The L1 measurement reporting format may indicate a type of cell (e.g., an activated serving cell, a deactivated cell, a non-serving cell, a PCell, a candidate PCell, a PSCell, and/or a candidate PSCell) and/or a type of L1 measurement data (e.g., an L1-RSRP measurement, an L1-SINR measurement, a filtered measurement across multiple beams, among other examples) associated with the L1 measurement reporting.

In some aspects, the L1 measurement reporting configuration may indicate that the L1 measurement reporting format corresponds to a mixed activated and deactivated cell report. In some aspects, the L1 measurement reporting configuration may indicate that the mixed activated and deactivated cell report includes L1 measurement data for one or more activated serving cells and one or more deactivated cells. In some aspects, the L1 measurement reporting configuration may indicate that the mixed activated and deactivated cell report includes L1 measurement data for one or more non-serving cells and one or more deactivated cells.

In some aspects, the L1 measurement reporting configuration may indicate that the L1 measurement reporting format corresponds to an activated serving cell report. In some aspects, the L1 measurement reporting configuration may indicate that the activated serving cell report includes L1 measurement data for one or more activated serving cells.

In some aspects, the L1 measurement reporting configuration may indicate that the L1 measurement reporting format corresponds to a non-serving cell report. In some aspects, the L1 measurement reporting configuration may indicate that the non-serving cell report includes L1 measurement data for one or more cells included in the non-serving cell set.

In some aspects, the L1 measurement reporting configuration may indicate that the L1 measurement reporting format corresponds to a deactivated cell report. In some aspects, the L1 measurement reporting configuration may indicate that the deactivated cell report includes L1 measurement data for one or more deactivated cells.

In some aspects, the L1 measurement reporting configuration may indicate multiple L1 measurement reporting formats. For example, the L1 measurement reporting configuration may indicate that the UE 120 is to transmit first L1 measurement reporting corresponding to an activated serving cell report and second L1 measurement reporting corresponding to a deactivated cell report.

In some aspects, the L1 measurement reporting configuration may indicate one or more other parameters associated with the L1 measurement reporting. For example, the L1 measurement reporting configuration may indicate a frequency at which activated serving cell reports are transmitted, a frequency at which non-serving cell reports are transmitted, a frequency at which deactivated cell reports are transmitted, a frequency at which mixed activated and deactivated cell reports are transmitted, one or more beams per reported PCI, a reporting quantity associated with L1-RSRP measurement data, a reporting quantity associated with L1-SINR measurement data, a quantity of filtered measurements across multiple beams for a cell, and/or differential reporting data with respect to a largest measurement value across reported PCIs, among other examples.

As shown by reference number 615, the UE 120 may obtain L1 measurement data for one or more cells included in the configured cell set according to the L1/L2 inter-cell mobility configuration and/or the L1 measurement reporting configuration. As shown by reference number 620, the UE 120 may transmit the L1 measurement reporting to the network node 605 according to the L1/L2 inter-cell mobility configuration and/or the L1 measurement reporting configuration.

As shown by reference number 625, the network node 605 and the UE 120 may communicate via L1/L2 signaling to modify the configured cell set based at least in part on the L1 measurement reporting. For example, based at least in part on L1 measurement data included in the L1 measurement reporting, the network node 605 and/or the UE 120 may utilize L1/L2 signaling to change a PCell associated with the UE 120, to activate a deactivated cell, to deactivate an activated serving cell, to move a cell from the activated serving cell set to the non-serving cell set, and/or to move a cell from the non-serving cell set to the activated serving cell.

As indicated above, FIG. 6 is provided as an example. Other examples may differ from what is described with respect to FIG. 6.

FIG. 7 is a diagram illustrating an example process 700 performed, for example, by a network node, in accordance with the present disclosure. Example process 700 is an example where the network node (e.g., network node 605) performs operations associated with L1/L2 inter-cell mobility measurement reporting.

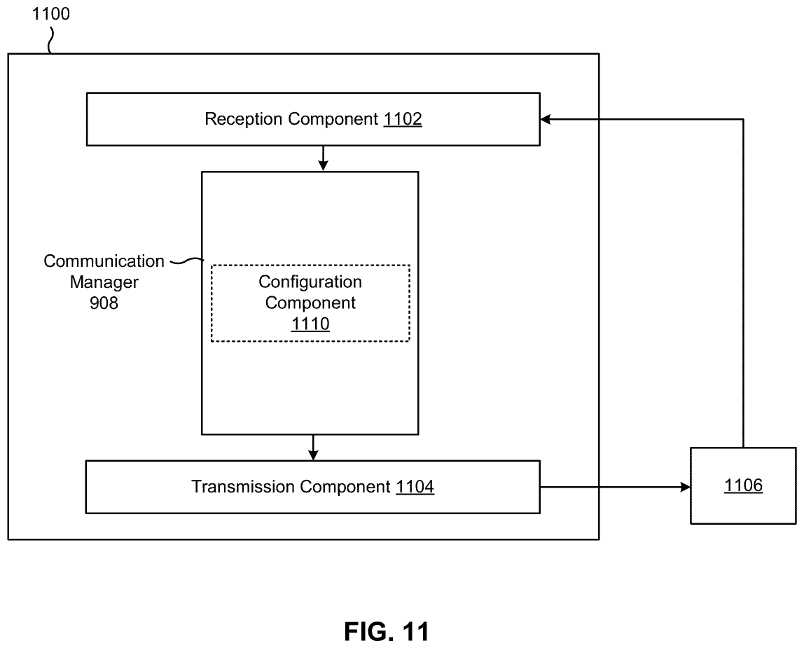

As shown in FIG. 7, in some aspects, process 700 may include transmitting a configuration associated with beam-based measurement reporting for a candidate cell group, wherein the candidate cell group is configured for L1/L2 mobility, and wherein the candidate cell group includes a deactivated cell (block 710). For example, the network node (e.g., using communication manager 1108 and/or transmission component 1104, depicted in FIG. 11) may transmit a configuration associated with beam-based measurement reporting for a candidate cell group, wherein the candidate cell group is configured for L1/L2 mobility, and wherein the candidate cell group includes a deactivated cell, as described above.

As further shown in FIG. 7, in some aspects, process 700 may include receiving a message indicating a beam-based measurement for the deactivated cell according to the configuration (block 720). For example, the network node (e.g., using communication manager 1108 and/or reception component 1102, depicted in FIG. 11) may receive a message indicating a beam-based measurement for the deactivated cell according to the configuration, as described above.

Process 700 may include additional aspects, such as any single aspect or any combination of aspects described below and/or in connection with one or more other processes described elsewhere herein.

In a first aspect, the configuration is transmitted via RRC signaling.

In a second aspect, alone or in combination with the first aspect, the beam-based measurement for the deactivated cell includes one or more of an L1 RSRP measurement associated with the deactivated cell or an L1 SINR measurement associated with the deactivated cell.

In a third aspect, alone or in combination with one or more of the first and second aspects, the configuration indicates that the beam-based measurement reporting comprises one or more of periodic L1 measurement reporting, semi-persistent L1 measurement reporting, aperiodic DCI triggered L1 measurement reporting, or aperiodic measurement triggered L1 measurement reporting.

In a fourth aspect, alone or in combination with one or more of the first through third aspects, the candidate cell group comprises a fixed group of cells that are preconfigured by the network node.

In a fifth aspect, alone or in combination with one or more of the first through fourth aspects, the candidate cell group includes a set of active serving cells and a set of non-serving cells, and the configuration indicates that L1/L2 measurement reporting is performed for the set of active serving cells.

In a sixth aspect, alone or in combination with one or more of the first through fifth aspects, the configuration indicates that L1/L2 measurement reporting includes one or more of one or more beams per each cell, of the candidate cell group, included in the L1/L2 measurement reporting, a quantity of L1-RSRP measurements included in the L1/L2 measurement reporting, a quantity of signal-to-interference-plus-noise ratios included in the L1/L2 measurement reporting, a quantity of filtered measurements across multiple beams for a cell, of the candidate cell group, included in the L1/L2 measurement reporting, or differential reporting with respect to a largest value across each cell, of the candidate cell group, included in the L1/L2 measurement reporting.

In a seventh aspect, alone or in combination with one or more of the first through sixth aspects, the candidate cell group includes a set of active serving cells associated with an active status and a set of non-serving cells associated with a candidate status, wherein the deactivated cell is associated with a deactivated status, and wherein the configuration indicates one or more beam-based measurement events associated with modifying a status associated with a cell.

In an eighth aspect, alone or in combination with one or more of the first through seventh aspects, the one or more beam-based measurement events include one or more of a measurement associated with a non-serving cell, of the set of non-serving cells, satisfying a first threshold, a measurement associated with an active serving cell, of the set of active serving cells, satisfying a second threshold, a measurement associated with the deactivated cell being at least a preconfigured amount different from a measurement associated with a primary cell, of the set of active serving cells, or the measurement associated with the primary cell satisfying a third threshold and the measurement associated with the deactivated cell satisfying a fourth threshold.

In a ninth aspect, alone or in combination with one or more of the first through eighth aspects, the configuration indicates one or more measurement events associated with updating a cell, of a set of activated serving cells included in the candidate cell group, wherein the cell is configured as a primary cell for a UE.

In a tenth aspect, alone or in combination with one or more of the first through ninth aspects, the one or more measurement events include one or more of a measurement associated with the primary cell satisfying a first threshold, or a measurement associated with another cell, of the set of activated serving cells, satisfying a second threshold, wherein the other cell is configured as a candidate primary cell for the UE.

In an eleventh aspect, alone or in combination with one or more of the first through tenth aspects, the message indicating the beam-based measurement for the deactivated cell is received via an activated serving cell, of the set of activated serving cells, using L1/L2 signaling.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with L1/L2 inter-cell mobility measurement reporting.

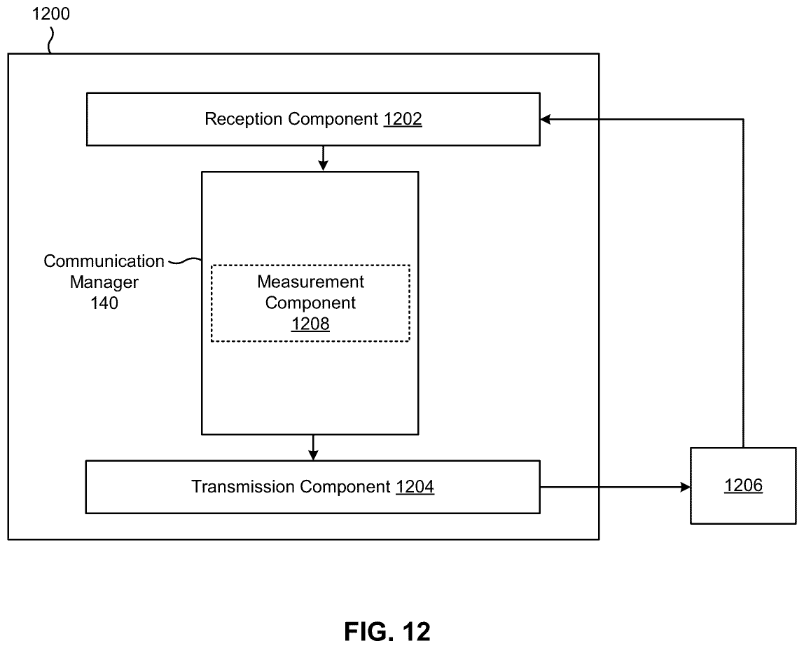

As shown in FIG. 8, in some aspects, process 800 may include receiving a configuration associated with beam-based measurement reporting for a candidate cell group, wherein the candidate cell group is configured for L1/L2 mobility, and wherein the candidate cell group includes a deactivated cell (block 810). For example, the UE (e.g., using communication manager 140 and/or reception component 1002, depicted in FIG. 12) may receive a configuration associated with beam-based measurement reporting for a candidate cell group, wherein the candidate cell group is configured for L1/L2 mobility, and wherein the candidate cell group includes a deactivated cell, as described above.

As further shown in FIG. 8, in some aspects, process 800 may include transmitting a message indicating a beam-based measurement for the deactivated cell according to the configuration (block 820). For example, the UE (e.g., using communication manager 140 and/or transmission component 1004, depicted in FIG. 12) may transmit a message indicating a beam-based measurement for the deactivated cell according to the configuration, as described above.

Process 800 may include additional aspects, such as any single aspect or any combination of aspects described below and/or in connection with one or more other processes described elsewhere herein.

In a first aspect, the configuration is received via RRC signaling.

In a second aspect, alone or in combination with the first aspect, the beam-based measurement for the deactivated cell includes one or more of an L1 RSRP measurement associated with the deactivated cell or an L1 SINR measurement associated with the deactivated cell.

In a third aspect, alone or in combination with one or more of the first and second aspects, the configuration indicates that the beam-based measurement reporting comprises one or more of periodic L1 measurement reporting, semi-persistent L1 measurement reporting, aperiodic DCI triggered L1 measurement reporting, or aperiodic measurement triggered L1 measurement reporting.

In a fourth aspect, alone or in combination with one or more of the first through third aspects, the candidate cell group comprises a fixed group of cells that are preconfigured by a network node.

In a fifth aspect, alone or in combination with one or more of the first through fourth aspects, the candidate cell group includes a set of active serving cells and a set of non-serving cells, and the configuration indicates that L1/L2 measurement reporting is performed for the set of active serving cells.

In a sixth aspect, alone or in combination with one or more of the first through fifth aspects, the configuration indicates that L1/L2 measurement reporting includes one or more of one or more beams per each cell, of the candidate cell group, included in the L1/L2 measurement reporting, a quantity of L1-RSRP measurements included in the L1/L2 measurement reporting, a quantity of signal-to-interference-plus-noise ratio included in the L1/L2 measurement reporting, a quantity of filtered measurements across multiple beams for a cell, of the candidate cell group, included in the L1/L2 measurement reporting, or differential reporting with respect to a largest value across each cell, of the candidate cell group, included in the L1/L2 measurement reporting.

In a seventh aspect, alone or in combination with one or more of the first through sixth aspects, the candidate cell group includes a set of active serving cells associated with an active status and a set of non-serving cells associated with a candidate status, wherein the deactivated cell is associated with a deactivated status, and wherein the configuration indicates one or more beam-based measurement events associated with modifying a status associated with a cell.

In an eighth aspect, alone or in combination with one or more of the first through seventh aspects, the one or more beam-based measurement events include one or more of a measurement associated with a non-serving cell, of the set of non-serving cells, satisfying a first threshold, a measurement associated with an active serving cell, of the set of active serving cells, satisfying a second threshold, a measurement associated with the deactivated cell being at least a preconfigured amount different from a measurement associated with a primary cell, of the set of active serving cells, or the measurement associated with the primary cell satisfying a third threshold and the measurement associated with the deactivated cell satisfying a fourth threshold.

In a ninth aspect, alone or in combination with one or more of the first through eighth aspects, the configuration indicates one or more measurement events associated with updating a cell, of a set of activated serving cells included in the candidate cell group, wherein the cell is configured as a primary cell for the UE.

In a tenth aspect, alone or in combination with one or more of the first through ninth aspects, the one or more measurement events include one or more of a measurement associated with the primary cell satisfying a first threshold, or a measurement associated with another cell, of the set of activated serving cells, satisfying a second threshold, wherein the other cell is configured as a candidate primary cell for the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by an UE, in accordance with the present disclosure. Example process 900 is an example where the UE (e.g., UE 120) performs operations associated with L1/L2 inter-cell mobility measurement reporting.

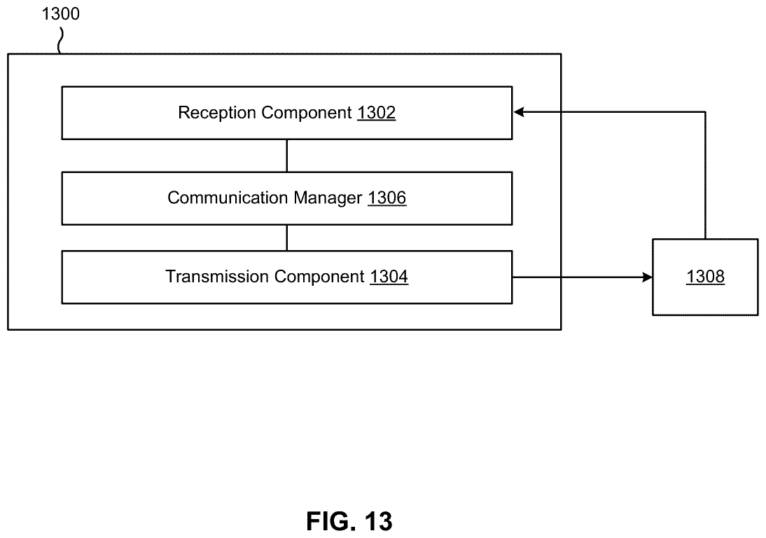

As shown in FIG. 9, in some aspects, process 900 may include determining that a condition associated with beam-based measurement reporting is satisfied (block 910). For example, the UE (e.g., using communication manager 1306, depicted in FIG. 13) may determine that a condition associated with beam-based measurement reporting is satisfied, as described above.

As further shown in FIG. 9, in some aspects, process 900 may include transmitting a beam-based measurement report based at least in part on the condition being satisfied (block 920). For example, the UE (e.g., using transmission component 1304 and/or communication manager 1306, depicted in FIG. 13) may transmit a beam-based measurement report based at least in part on the condition being satisfied, as described above.

Process 900 may include additional aspects, such as any single aspect or any combination of aspects described below and/or in connection with one or more other processes described elsewhere herein.

In a first aspect, process 900 includes receiving one or more of an activation command associated with a transmission on a PUCCH or downlink control information (DCI) associated with a transmission on a PUSCH, wherein the condition is satisfied based at least in part on receiving the one or more of the activation command or the DCI.

In a second aspect, alone or in combination with the first aspect, the condition is satisfied based at least in part on an occurrence of a measurement event.

In a third aspect, alone or in combination with one or more of the first and second aspects, the measurement event includes one or more of a beam-based measurement for an activated serving cell associated with the UE, a beam-based measurement for a non-serving cell associated with the UE, or a beam-based measurement for a deactivated cell associated with the UE satisfying a measurement threshold.

In a fourth aspect, alone or in combination with one or more of the first through third aspects, the UE is associated with a candidate cell set, and wherein the measurement event includes a beam-based measurement for a first cell, of the candidate cell set, being at least an offset different than a beam-based measurement for a second cell, of the candidate cell set.

In a fifth aspect, alone or in combination with one or more of the first through fourth aspects, the condition is satisfied based at least in part on an occurrence of multiple measurement events.

In a sixth aspect, alone or in combination with one or more of the first through fifth aspects, the UE is associated with a candidate cell group, and wherein the multiple measurement events include a beam-based measurement for an activated serving cell, of the candidate cell group, satisfying a first threshold and one or more of a beam-based measurement for a non-serving cell, of the candidate cell group, satisfying a second threshold, or a beam-based measurement for a deactivated cell, of the candidate cell group, satisfying a third threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with L1/L2 inter-cell mobility measurement reporting.

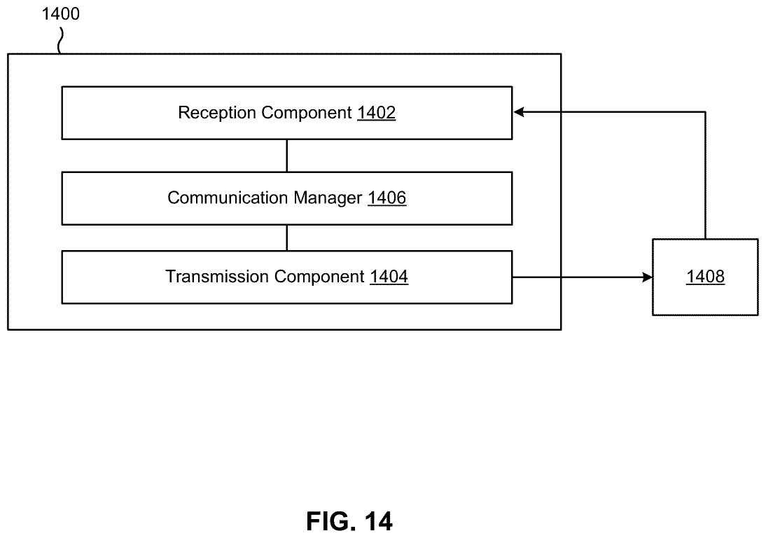

As shown in FIG. 10, in some aspects, process 1000 may include transmitting a configuration for UE-triggered beam-based measurement reporting, the configuration indicating that a beam-based measurement report is transmitted by a UE based at least in part on a condition associated with beam-based measurement reporting being satisfied (block 1010). For example, the network node (e.g., using transmission component 1404 and/or communication manager 1406, depicted in FIG. 14) may transmit a configuration for UE-triggered beam-based measurement reporting, the configuration indicating that a beam-based measurement report is transmitted by a UE based at least in part on a condition associated with beam-based measurement reporting being satisfied, as described above.

As further shown in FIG. 10, in some aspects, process 1000 may include receiving the beam-based measurement report based at least in part on the condition being satisfied (block 1020). For example, the network node (e.g., using reception component 1402 and/or communication manager 1406, depicted in FIG. 14) may receive the beam-based measurement report based at least in part on the condition being satisfied, as described above.

Process 1000 may include additional aspects, such as any single aspect or any combination of aspects described below and/or in connection with one or more other processes described elsewhere herein.

In a first aspect, process 1000 includes transmitting one or more of an activation command associated with a transmission on a PUCCH or DCI associated with a transmission on a PUSCH, wherein the condition is satisfied based at least in part on the UE receiving the one or more of the activation command or the DCI.

In a second aspect, alone or in combination with the first aspect, the condition is satisfied based at least in part on an occurrence of a measurement event, and wherein the measurement event includes one or more of a beam-based measurement for an activated serving cell associated with the UE, a beam-based measurement for a non-serving cell associated with the UE, or a beam-based measurement for a deactivated cell associated with the UE satisfying a measurement threshold.

In a third aspect, alone or in combination with one or more of the first and second aspects, the UE is associated with a candidate cell group, and wherein the measurement event includes a beam-based measurement for a first cell, of the candidate cell group, being at least an offset different than a beam-based measurement for a second cell, of the candidate cell group.

In a fourth aspect, alone or in combination with one or more of the first through third aspects, the condition is satisfied based at least in part on an occurrence of multiple measurement events, wherein the UE is associated with a candidate cell group, and wherein the multiple measurement events include a beam-based measurement for an activated serving cell, of the candidate cell group, satisfying a first threshold and one or more of a beam-based measurement for a non-serving cell, of the candidate cell group, satisfying a second threshold, or a beam-based measurement for a deactivated cell, of the candidate cell group, satisfying a third threshold.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108.

The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the base station described in connection with FIG. 2. The communication manager 1108 may be, or be similar to, the communication manager 150 depicted in FIGS. 1 and 2. For example, in some aspects, the communication manager 1108 may be configured to perform one or more of the functions described as being performed by the communication manager 150. In some aspects, the communication manager 1108 may include the reception component 1102 and/or the transmission component 1104. The communication manager 1108 may include a configuration component 1110, among other examples.

In some aspects, the apparatus 1100 may be configured to perform one or more operations described herein in connection with FIGS. 5 and 6. Additionally, or alternatively, the apparatus 1100 may be configured to perform one or more processes described herein, such as process 700 of FIG. 7 and/or process 1000 of FIG. 10. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit a configuration associated with beam-based measurement reporting for a candidate cell group. The configuration component 1110 may configure the candidate cell group for L1/L2 mobility. The candidate cell group may include a deactivated cell. The reception component 1102 may receive a message indicating a beam-based measurement for the deactivated cell according to the configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a measurement component 1208, among other examples.

In some aspects, the apparatus 1200 may be configured to perform one or more operations described herein in connection with FIGS. 5 and 6. Additionally, or alternatively, the apparatus 1200 may be configured to perform one or more processes described herein, such as process 800 of FIG. 8 and/or process 900 of FIG. 9. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive a configuration associated with beam-based measurement reporting for a candidate cell group, wherein the candidate cell group is configured for L1/L2 mobility, and wherein the candidate cell group includes a deactivated cell. The measurement component 1208 may obtain beam-based measurement data according to the configuration. The transmission component 1204 may transmit a message indicating a beam-based measurement for the deactivated cell according to the configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 5-6. Additionally, or alternatively, the apparatus 1300 may be configured to perform one or more processes described herein, such as process 800 of FIG. 8, process 900 of FIG. 9, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 5-6. Additionally, or alternatively, the apparatus 1400 may be configured to perform one or more processes described herein, such as process 700 of FIG. 7, process 1000 of FIG. 10, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a network node, comprising: transmitting a configuration associated with beam-based measurement reporting for a candidate cell group, wherein the candidate cell group is configured for L1/L2 mobility, and wherein the candidate cell group includes a deactivated cell; and receiving a message indicating a beam-based measurement for the deactivated cell according to the configuration.

Aspect 2: The method of Aspect 1, wherein the configuration is transmitted via RRC signaling.

Aspect 3: The method of one or more of Aspects 1 and 2, wherein the beam-based measurement for the deactivated cell includes one or more of an L1 RSRP measurement associated with the deactivated cell or an L1 SINR measurement associated with the deactivated cell.

Aspect 4: The method of one or more of Aspects 1 through 3, wherein the configuration indicates that the beam-based measurement reporting comprises one or more of periodic beam-based measurement reporting, semi-persistent beam-based measurement reporting, aperiodic DCI triggered beam-based measurement reporting, or aperiodic measurement triggered beam-based measurement reporting.

Aspect 5: The method of one or more of Aspects 1 through 4, wherein the candidate cell group comprises a fixed group of cells that are preconfigured by the network node.

Aspect 6: The method of one or more of Aspects 1 through 5, wherein the candidate cell group includes a set of active serving cells and a set of non-serving cells, and wherein the configuration indicates that L1/L2 measurement reporting is performed for the set of active serving cells.

Aspect 7: The method of one or more of Aspects 1 through 6, wherein the configuration indicates that L1/L2 measurement reporting includes one or more of: one or more beams per each cell, of the candidate cell group, included in the L1/L2 measurement reporting, a quantity of L1-RSRP measurements included in the L1/L2 measurement reporting, a quantity of signal-to-interference-plus-noise ratios included in the L1/L2 measurement reporting, a quantity of filtered measurements across multiple beams for a cell, of the candidate cell group, included in the L1/L2 measurement reporting, or differential reporting with respect to a largest value across each cell, of the candidate cell group, included in the L1/L2 measurement reporting.

Aspect 8: The method of one or more of Aspects 1 through 8, wherein the candidate cell group includes a set of active serving cells associated with an active status and a set of non-serving cells associated with a candidate status, wherein the deactivated cell is associated with a deactivated status, and wherein the configuration indicates one or more beam-based measurement events associated with modifying a status associated with a cell.

Aspect 9: The method of Aspect 8, wherein the one or more beam-based measurement events include one or more of: a measurement associated with a non-serving cell, of the set of non-serving cells, satisfying a first threshold, a measurement associated with an active serving cell, of the set of active serving cells, satisfying a second threshold, a measurement associated with the deactivated cell being at least a preconfigured amount different from a measurement associated with a primary cell, of the set of active serving cells, or the measurement associated with the primary cell satisfying a third threshold and the measurement associated with the deactivated cell satisfying a fourth threshold.

Aspect 10: The method of one or more of Aspects 1 through 9, wherein the configuration indicates one or more measurement events associated with updating a cell, of a set of activate serving cells included in the candidate cell group, wherein the cell is configured as a primary cell for a UE.

Aspect 11: The method of Aspect 10, wherein the one or more measurement events include one or more of: a measurement associated with the primary cell satisfying a first threshold, or a measurement associated with another cell, of the set of activate serving cells, satisfying a second threshold, wherein the other cell is configured as a candidate primary cell for the UE.

Aspect 12: The method of one or more of Aspects 1 through 10, wherein the configuration indicates one or more measurement events associated with updating a cell, of the set of activate serving cells, configured as a primary cell for a UE.

Aspect 13: A method of wireless communication performed by a UE, comprising: receiving a configuration associated with beam-based measurement reporting for a candidate cell group, wherein the candidate cell group is configured for L1/L2 mobility, and wherein the candidate cell group includes a deactivated cell; and transmitting a message indicating a beam-based measurement for the deactivated cell according to the configuration.

Aspect 14: The method of Aspect 13, wherein the configuration is received via RRC signaling.

Aspect 15: The method of one or more of Aspects 13 and 14, wherein the beam-based measurement for the deactivated cell includes one or more of an L1 RSRP measurement associated with the deactivated cell or an L1 SINR measurement associated with the deactivated cell.

Aspect 16: The method of one or more of Aspects 13 through 15, wherein the configuration indicates that the beam-based measurement reporting comprises one or more of periodic beam-based measurement reporting, semi-persistent beam-based measurement reporting, aperiodic DCI triggered beam-based measurement reporting, or aperiodic measurement triggered beam-based measurement reporting.

Aspect 17: The method of one or more of Aspects 13 through 16, wherein the candidate cell group comprises a fixed group of cells that are preconfigured by a network node.

Aspect 18: The method of one or more of Aspects 13 through 17, wherein the candidate cell group includes a set of active serving cells and a set of non-serving cells, and wherein the configuration indicates that L1/L2 measurement reporting is performed for the set of active serving cells.

Aspect 19: The method of one or more of Aspects 13 through 18, wherein the configuration indicates that L1/L2 measurement reporting includes one or more of: one or more beams per each cell, of the candidate cell group, included in the L1/L2 measurement reporting, a quantity of L1-RSRP measurements included in the L1/L2 measurement reporting, a quantity of signal-to-interference-plus-noise ratio included in the L1/L2 measurement reporting, a quantity of filtered measurements across multiple beams for a cell, of the candidate cell group, included in the L1/L2 measurement reporting, or differential reporting with respect to a largest value across each cell, of the candidate cell group, included in the L1/L2 measurement reporting.

Aspect 20: The method of one or more of Aspects 13 through 19, wherein the candidate cell group includes a set of active serving cells associated with an active status and a set of non-serving cells associated with a candidate status, wherein the deactivated cell is associated with a deactivated status, and wherein the configuration indicates one or more beam-based measurement events associated with modifying a status associated with a cell.

Aspect 21: The method of Aspect 20, wherein the one or more beam-based measurement events include one or more of: a measurement associated with a non-serving cell, of the set of non-serving cells, satisfying a first threshold, a measurement associated with an active serving cell, of the set of active serving cells, satisfying a second threshold, a measurement associated with the deactivated cell being at least a preconfigured amount different from a measurement associated with a primary cell, of the set of active serving cells, or the measurement associated with the primary cell satisfying a third threshold and the measurement associated with the deactivated cell satisfying a fourth threshold.

Aspect 22: The method of one or more of Aspects 13 through 21, wherein the configuration indicates one or more measurement events associated with updating a cell, of a set of activate serving cells included in the candidate cell group, wherein the cell is configured as a primary cell for the UE.

Aspect 23: The method of Aspect 22, wherein the one or more measurement events include one or more of: a measurement associated with the primary cell satisfying a first threshold, or a measurement associated with another cell, of the set of activate serving cells, satisfying a second threshold, wherein the other cell is configured as a candidate primary cell for the UE.

Aspect 24: A method of wireless communication performed by a UE, comprising: determining that a condition associated with beam-based measurement reporting is satisfied; and transmitting a beam-based measurement report based at least in part on the condition being satisfied.

Aspect 25: The method of Aspect 24, further comprising: receiving one or more of an activation command associated with a transmission on a PUCCH or DCI associated with a transmission on a PUSCH, wherein the condition is satisfied based at least in part on receiving the one or more of the activation command or the DCI.

Aspect 26: The method of one or more of Aspects 24 and 25, wherein the condition is satisfied based at least in part on an occurrence of a measurement event.

Aspect 27: The method of Aspect 26, wherein the measurement event includes one or more of a beam-based measurement for an activated serving cell associated with the UE, a beam-based measurement for a non-serving cell associated with the UE, or a beam-based measurement for a deactivated cell associated with the UE satisfying a measurement threshold.

Aspect 28: The method of Aspect 26, wherein the UE is associated with a candidate cell group, and wherein the measurement event includes a beam-based measurement for a first cell, of the candidate cell group, being at least an offset different than a beam-based measurement for a second cell, of the candidate cell group.

Aspect 29: The method of Aspect 28, wherein the condition is satisfied based at least in part on an occurrence of multiple measurement events.

Aspect 30: The method of Aspect 29, wherein the UE is associated with a candidate cell group, and wherein the multiple measurement events include a beam-based measurement for an activated serving cell, of the candidate cell group, satisfying a first threshold and one or more of: a beam-based measurement for a non-serving cell, of the candidate cell group, satisfying a second threshold, or a beam-based measurement for a deactivated cell, of the candidate cell group, satisfying a third threshold.

Aspect 31: A method of wireless communication performed by a network node, comprising transmitting a configuration for UE-triggered beam-based measurement reporting, the configuration indicating that a beam-based measurement report is transmitted by a UE based at least in part on a condition associated with beam-based measurement reporting being satisfied; and receiving the beam-based measurement report based at least in part on the condition being satisfied.

Aspect 32: The method of Aspect 31, further comprising transmitting one or more of an activation command associated with a transmission on a PUCCH or DCI associated with a transmission on a PUSCH, wherein the condition is satisfied based at least in part on the UE receiving the one or more of the activation command or the DCI.

Aspect 33: The method of one or more of Aspects 31 and 32, wherein the condition is satisfied based at least in part on an occurrence of a measurement event, and wherein the measurement event includes one or more of a beam-based measurement for an activated serving cell associated with the UE, a beam-based measurement for a non-serving cell associated with the UE, or a beam-based measurement for a deactivated cell associated with the UE satisfying a measurement threshold.

Aspect 34: The method of Aspect 33, wherein the UE is associated with a candidate cell group, and wherein the measurement event includes a beam-based measurement for a first cell, of the candidate cell group, being at least an offset different than a beam-based measurement for a second cell, of the candidate cell group.

Aspect 35: The method of one or more of Aspects 31-34, wherein the condition is satisfied based at least in part on an occurrence of multiple measurement events, wherein the UE is associated with a candidate cell group, and wherein the multiple measurement events include a beam-based measurement for an activated serving cell, of the candidate cell group, satisfying a first threshold and one or more of a beam-based measurement for a non-serving cell, of the candidate cell group, satisfying a second threshold, or a beam-based measurement for a deactivated cell, of the candidate cell group, satisfying a third threshold.

Aspect 36: An apparatus for wireless communication at a device, comprising a processor; memory coupled with the processor; and instructions stored in the memory and executable by the processor to cause the apparatus to perform the method of one or more of Aspects 1 through 12.

Aspect 37: A device for wireless communication, comprising a memory and one or more processors coupled to the memory, the one or more processors configured to perform the method of one or more of Aspects 1 through 12.

Aspect 38: An apparatus for wireless communication, comprising at least one means for performing the method of one or more of Aspects 1 through 12.

Aspect 39: A non-transitory computer-readable medium storing code for wireless communication, the code comprising instructions executable by a processor to perform the method of one or more of Aspects 1 through 12.

Aspect 40: A non-transitory computer-readable medium storing a set of instructions for wireless communication, the set of instructions comprising one or more instructions that, when executed by one or more processors of a device, cause the device to perform the method of one or more of Aspects 1 through 12.

Aspect 41: An apparatus for wireless communication at a device, comprising a processor; memory coupled with the processor; and instructions stored in the memory and executable by the processor to cause the apparatus to perform the method of one or more of Aspects 13 through 23.

Aspect 42: A device for wireless communication, comprising a memory and one or more processors coupled to the memory, the one or more processors configured to perform the method of one or more of Aspects 13 through 23.

Aspect 43: An apparatus for wireless communication, comprising at least one means for performing the method of one or more of Aspects 13 through 23.

Aspect 44: A non-transitory computer-readable medium storing code for wireless communication, the code comprising instructions executable by a processor to perform the method of one or more of Aspects 13 through 23.

Aspect 45: A non-transitory computer-readable medium storing a set of instructions for wireless communication, the set of instructions comprising one or more instructions that, when executed by one or more processors of a device, cause the device to perform the method of one or more of Aspects 13 through 23.

Aspect 46: An apparatus for wireless communication at a device, comprising a processor; memory coupled with the processor; and instructions stored in the memory and executable by the processor to cause the apparatus to perform the method of one or more of Aspects 24 through 30.

Aspect 47: A device for wireless communication, comprising a memory and one or more processors coupled to the memory, the one or more processors configured to perform the method of one or more of Aspects 24 through 30.

Aspect 48: An apparatus for wireless communication, comprising at least one means for performing the method of one or more of Aspects 24 through 30.

Aspect 49: A non-transitory computer-readable medium storing code for wireless communication, the code comprising instructions executable by a processor to perform the method of one or more of Aspects 24 through 30.

Aspect 50: A non-transitory computer-readable medium storing a set of instructions for wireless communication, the set of instructions comprising one or more instructions that, when executed by one or more processors of a device, cause the device to perform the method of one or more of Aspects 24 through 30.

Aspect 51: An apparatus for wireless communication at a device, comprising a processor; memory coupled with the processor; and instructions stored in the memory and executable by the processor to cause the apparatus to perform the method of one or more of Aspects 31 through 35.

Aspect 52: A device for wireless communication, comprising a memory and one or more processors coupled to the memory, the one or more processors configured to perform the method of one or more of Aspects 31 through 35.

Aspect 53: An apparatus for wireless communication, comprising at least one means for performing the method of one or more of Aspects 24 through 30.

Aspect 54: A non-transitory computer-readable medium storing code for wireless communication, the code comprising instructions executable by a processor to perform the method of one or more of Aspects 31 through 35.

Aspect 55: A non-transitory computer-readable medium storing a set of instructions for wireless communication, the set of instructions comprising one or more instructions that, when executed by one or more processors of a device, cause the device to perform the method of one or more of Aspects 31 through 35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
a memory; and
one or more processors, coupled to the memory, configured to:
transmit a configuration associated with beam-based measurement reporting for a candidate cell set, wherein the candidate cell set is configured for layer 1 (L1)/layer 2 (L2) mobility, and wherein the candidate cell set includes a deactivated cell; and
receive a message indicating beam-based measurement for the deactivated cell according to the configuration.

2. The network node of claim 1, wherein the message indicating the beam-based measurement for the deactivated cell is received via an activated serving cell, included in the candidate cell set, using L1/L2 signaling.

3. The network node of claim 1, wherein the beam-based measurement for the deactivated cell includes one or more of an L1 reference signal received power (RSRP) measurement associated with the deactivated cell or an L1 signal-to-interference-plus-noise ratio (SINR) measurement associated with the deactivated cell.

4. The network node of claim 1, wherein the configuration indicates that the beam-based measurement reporting comprises one or more of periodic beam-based measurement reporting, semi-persistent beam-based measurement reporting, aperiodic downlink control information (DCI) triggered L1 measurement reporting, or aperiodic measurement triggered beam-based measurement reporting.

5. The network node of claim 1, wherein the candidate cell set includes a set of active serving cells and a set of non-serving cells, and wherein the configuration indicates that L1/L2 measurement reporting is performed for the set of active serving cells.

6. The network node of claim 1, wherein the configuration indicates that L1/L2 measurement reporting includes one or more of:
one or more beams per each cell, of the candidate cell set, included in the L1/L2 measurement reporting,
a quantity of beam-based-RSRP measurements included in the L1/L2 measurement reporting,
a quantity of signal-to-interference-plus-noise ratios included in the L1/L2 measurement reporting,
a quantity of filtered measurements across multiple beams for a cell, of the candidate cell group, included in the L1/L2 measurement reporting, or
differential reporting with respect to a largest value across each cell, of the candidate cell set, included in the L1/L2 measurement reporting.

7. The network node of claim 1, wherein the candidate cell set includes a set of active serving cells associated with an active status and a set of non-serving cells associated with a candidate status, wherein the deactivated cell is associated with a deactivated status, and wherein the configuration indicates one or more beam-based measurement events associated with modifying a status associated with a cell.

8. The network node of claim 7, wherein the one or more beam-based measurement events include one or more of:
a measurement associated with a non-serving cell, of the set of non-serving cells, satisfying a first threshold,
a measurement associated with an active serving cell, of the set of active serving cells, satisfying a second threshold,
a measurement associated with the deactivated cell being at least a preconfigured amount different from a measurement associated with a primary cell, of the set of active serving cells, or
the measurement associated with the primary cell satisfying a third threshold and the measurement associated with the deactivated cell satisfying a fourth threshold.

9. The network node of claim 1, wherein the configuration indicates one or more measurement events associated with updating a cell, of a set of activated serving cells, included in the candidate cell set, wherein the cell is configured as a primary cell for a user equipment (UE).

10. The network node of claim 9, wherein the one or more measurement events include one or more of:
a measurement associated with the primary cell satisfying a first threshold, or
a measurement associated with another cell, of the set of activated serving cells, satisfying a second threshold, wherein the other cell is configured as a candidate primary cell for the UE.

11. A user equipment (UE) for wireless communication, comprising:
a memory; and
one or more processors, coupled to the memory, configured to:
receive a configuration associated with beam-based measurement reporting for a candidate cell set, wherein the candidate cell set is configured for layer 1 (L1)/layer 2 (L2) mobility, and wherein the candidate cell set includes a deactivated cell; and
transmit a message indicating a beam-based measurement for the deactivated cell according to the configuration.

12. The UE of claim 11, wherein the beam-based measurement for the deactivated cell includes one or more of an L1 reference signal received power (RSRP) measurement associated with the deactivated cell or an L1 signal-to-interference-plus-noise ratio (SINR) measurement associated with the deactivated cell.

13. The UE of claim 11, wherein the configuration indicates that the beam-based measurement reporting comprises one or more of periodic beam-based measurement reporting, semi-persistent beam-based measurement reporting, aperiodic downlink control information (DCI) triggered beam-based measurement reporting, or aperiodic measurement triggered beam-based measurement reporting.

14. The UE of claim 11, wherein the configuration indicates that L1/L2 measurement reporting includes one or more of:
one or more beams per each cell, of the candidate cell set, included in the L1/L2 measurement reporting,
a quantity of L1-RSRP measurements included in the L1/L2 measurement reporting,
a quantity of signal-to-interference-plus-noise ratio included in the L1/L2 measurement reporting,
a quantity of filtered measurements across multiple beams for a cell, of the candidate cell set, included in the L1/L2 measurement reporting, or
differential reporting with respect to a largest value across each cell, of the candidate cell set, included in the L1/L2 measurement reporting.

15. The UE of claim 11, wherein the candidate cell set includes a set of active serving cells associated with an active status and a set of non-serving cells associated with a candidate status, wherein the deactivated cell is associated with a deactivated status, and wherein the configuration indicates one or more beam-based measurement events associated with modifying a status associated with a cell.

16. The UE of claim 15, wherein the one or more beam-based measurement events include one or more of:
a measurement associated with a non-serving cell, of the set of non-serving cells, satisfying a first threshold,
a measurement associated with an active serving cell, of the set of active serving cells, satisfying a second threshold,
a measurement associated with the deactivated cell being at least a preconfigured amount different from a measurement associated with a primary cell, of the set of active serving cells, or
the measurement associated with the primary cell satisfying a third threshold and the measurement associated with the deactivated cell satisfying a fourth threshold.

17. The UE of claim 11, wherein the configuration indicates one or more measurement events associated with updating a cell, of a set of activated serving cells included in the candidate cell set, wherein the cell is configured as a primary cell for the UE.

18. The UE of claim 17, wherein the one or more measurement events include one or more of:
a measurement associated with the primary cell satisfying a first threshold, or
a measurement associated with another cell, of the set of activated serving cells, satisfying a second threshold, wherein the other cell is configured as a candidate primary cell for the UE.

19. A user equipment (UE) for wireless communication, comprising:
a memory; and
one or more processors, coupled to the memory, configured to:
determine that a condition associated with beam-based measurement reporting is satisfied; and
transmit a beam-based measurement report based at least in part on the condition being satisfied.

20. The UE of claim 19, wherein the one or more processors are further configured to:
receive one or more of an activation command associated with a transmission on a physical uplink control channel (PUCCH) or downlink control information (DCI) associated with a transmission on a physical uplink shared channel (PUSCH), wherein the condition is satisfied based at least in part on receiving the one or more of the activation command or the DCI.

21. The UE of claim 19, wherein the condition is satisfied based at least in part on an occurrence of a measurement event.

22. The UE of claim 21, wherein the measurement event includes one or more of:
a beam-based measurement for an activated serving cell associated with the UE,
a beam-based measurement for a non-serving cell associated with the UE, or
a beam-based measurement for a deactivated cell associated with the UE satisfying a measurement threshold.

23. The UE of claim 21, wherein the UE is associated with a candidate cell set, and wherein the measurement event includes a beam-based measurement for a first cell, of the candidate cell set, being at least an offset different than a beam-based measurement for a second cell, of the candidate cell set.

24. The UE of claim 23, wherein the condition is satisfied based at least in part on an occurrence of multiple measurement events.

25. The UE of claim 24, wherein the UE is associated with a group of cells, and wherein the multiple measurement events include:
a beam-based measurement for an activated serving cell, of the candidate cell set, satisfying a first threshold and one or more of:
a beam-based measurement for a non-serving cell, of the candidate cell set, satisfying a second threshold, or
a beam-based measurement for a deactivated cell, of the candidate cell set, satisfying a third threshold.

26. A network node for wireless communication, comprising:
a memory; and
one or more processors, coupled to the memory, configured to:
transmit a configuration for user equipment (UE)-triggered beam-based measurement reporting, the configuration indicating that a beam-based measurement report is transmitted by a UE based at least in part on a condition associated with beam-based measurement reporting being satisfied; and
receive the beam-based measurement report based at least in part on the condition being satisfied.

27. The network node of claim 26, wherein the one or more processors are further configured to:
transmit one or more of an activation command associated with a transmission on a physical uplink control channel (PUCCH) or downlink control information (DCI) associated with a transmission on a physical uplink shared channel (PUSCH), wherein the condition is satisfied based at least in part on the UE receiving the one or more of the activation command or the DCI.

28. The network node of claim 26, wherein the condition is satisfied based at least in part on an occurrence of a measurement event, and wherein the measurement event includes one or more of:
a beam-based measurement for an activated serving cell associated with the UE,
a beam-based measurement for a non-serving cell associated with the UE, or
a beam-based measurement for a deactivated cell associated with the UE satisfying a measurement threshold.

29. The network node of claim 28, wherein the UE is associated with a candidate cell group, and wherein the measurement event includes a beam-based measurement for a first cell, of the candidate cell group, being at least an offset different than a beam-based measurement for a second cell, of the candidate cell group.

30. The network node of claim 26, wherein the condition is satisfied based at least in part on an occurrence of multiple measurement events, wherein the UE is associated with a candidate cell group, and wherein the multiple measurement events include:
a beam-based measurement for an activated serving cell, of the candidate cell group, satisfying a first threshold and one or more of:
a beam-based measurement for a non-serving cell, of the candidate cell group, satisfying a second threshold, or
a beam-based measurement for a deactivated cell, of the candidate cell group, satisfying a third threshold.
